(19) United States
(12) Patent Application Publication
(10) Pub. No.: US 2008/0046378 A1
(43) Pub. Date: Feb. 21, 2008

(54) System and method for selling software on a pay-per-use basis

(75) Inventors: Sean Harrison, Herzogenasurach (DE); Rainer Kuth, Hochstadt (DE)

Correspondence Address: BRINKS HOFER GILSON & LIONE, P.O. BOX 10395, CHICAGO, IL, 60610, US

(73) Assignee: Siemens Aktiengesellschaft

(21) Appl. No.: 11/506,820

(22) Filed: Aug. 18, 2006

(51) Int. Cl. G06Q 99/00

(52) U.S. Cl. 705/59

(57) ABSTRACT

A system and method of providing after sales support for medical systems is described. During the economic lifetime of a medical system, new or modified software modules may become available as a result of advances in medical knowledge or the technology of the medical system. Such updates or improvements may be provided to customers with suitable existing medical systems by making such modules available for licensing on a pay-per-use or a paid-up license basis. Information regarding the after sales support is maintained on a data base by the manufacturer and provided to customers over a wide-area network. The information may be customized on the basis of the existing configuration of the customer medical system to indicate the additional modules that are available.

### TECHNICAL FIELD

This application pertains to a system and method for providing after sales support to a purchaser of a medical system, and in particular to a method of rapidly making new software modules available for use with existing medical systems.

### BACKGROUND

When medical systems or other computer-based apparatus are marketed and sold, there are many options available to the customer at the time of purchase. At a later date, further options, upgrades and improvements may be come available during the economic life of the medical system product. Many of these options, upgrades or improvements are software, although some of them may require hardware changes as well. These options, upgrades and improvements are termed “after sales support”, and may include other services, training and the like. Very often, the support organization of the manufacturer is organized to make the initial sale, but the marketing and sale of after sales support tends to be inefficient, uneconomic and ineffective due to the lack of effective identification of customers for the options and the typically smaller economic value of the after sales support. However, from a customer viewpoint, such after sales support is an important portion of the maintenance and use of the medical system over the useable lifetime thereof.

Where identification of available after sales support is difficult, customers may not be aware of the availability of the new item, and thus may not be able to use a new item with the existing medical system to provide patient care. As such, newer techniques may only be identified when, for example, a radiology department purchases a new medical system, even though the improvement was available through the purchase of an element of after sales support for an existing system.

Trial licenses for software are known, in which the license has a limited life; for example, three months. After that time, the customer must decide to purchase a license to continue to use the function provided by the after sales support. The trial period is intended to provide the customer with a means of evaluating the item to determine if the item is practical and economic in the particular use environment. However, from the supplier viewpoint, administrative expenses for trial licenses tend to be high as, with many of these items, training and troubleshooting is required. This situation is particularly uneconomic for the manufacturer if the customer does not purchase a license at the end of a trial period.

Periodically, the manufacturer of the medical system will release new software versions. These new software versions include improvements of functions and additional functions, for which separate licenses are usually needed. Each customer, or those customers having a service agreement, will receive new software versions, but does not have a license to use for the new functions, as the updated function may require an addition or change to the license that the customer obtained at the time of initial purchase. The customers can buy licenses for some of these functions, but as each new function is usually of interest to only a small number of users of the system, the customer organization may not be interested in obtaining a license. Providing a means for the interested users of the customer to try the software may increase license sales.

### SUMMARY

A data processing system for providing after sales support of a medical system is described, including a server communicating with a wide-area network and a data base. The server is configured to receive requests for information relating to software modules available for a specific medical system, and the information is transmitted to the requestor.

In another aspect, a method of selling after sales support for a medical system is described, the method including: creating and maintaining a data base of software modules available for a specific model of a medical system; receiving a request for information regarding after sales support from a customer over a wide-area network; comparing the request for information from a customer with a record of a configuration of modules of the customer owned specific model of the medical system; identifying modules available for the specific module of the medical system that are not owned or licensed by the customer; and, providing information about the modules to the customer by transmitting the information over the wide-area network.

In another aspect, the customer receives updated software by any means, including removable recording media such as CD-ROM or DVD-ROM or the like, the Internet, a virtual private network (VPN) or the like, and the software is one of automatically or manually installed on the target system. After installing the updated or new software the customer may obtain a pay-per-use license to all functions, or to the new or updated functions. The initial pay-per-use license may be on a credit base for a fixed number of uses (patients), and then further licenses or license keys for fixed numbers of uses may be purchased. In an aspect, the initial pay-per-use license may be gratis, as a trial license, or have a usage fee.

Alternatively, the customer may buy a “one-time-payment” license for some or all of the updated or new software, and such a license may be less expensive for frequent use. “One-time-payment” licenses and “pay-per-use-licenses” may exist simultaneously for the system or customer site for different functional aspects of the software for a system.

In still another aspect, a method of purchasing after sales support for a medical system is described, the method including: requesting information regarding after sales support from a manufacturer over a wide-area network;

receiving information from the manufacturer regarding available software modules for the specific model and configuration of medical system owned by the customer, the information being received as data modulated on a carrier wave; selecting a specific module from the one or more available software modules, including a type of use license; and, sending a purchase request or purchase order or similar request for the selected module to the manufacturer.

### BRIEF DESCRIPTION OF THE DRAWINGS

FIG. 1 is a system block diagram illustrating the interaction between a customer and a supplier in the purchase of after sales support for a medical system; and

FIG. 2 is a block diagram of the process of one aspect of providing after sales customer support.

### DETAILED DESCRIPTION

Exemplary embodiments may be better understood with reference to the drawings, but these embodiments are not intended to be of a limiting nature. Like numbered elements in the same or different drawings perform similar functions.

A combination of hardware and software to accomplish the tasks described herein may termed a computing system, server, client equipment, or generally a platform. The instructions for implementing processes of the platform, the processes of a client application, or the processes of a server are provided on computer-readable storage media or memories, such as a cache, buffer, RAM, ROM, removable media, hard drive or other computer readable electrical, optical and magnetic storage media. Computer readable storage media include various types of volatile and nonvolatile storage media. The functions, acts, tasks or displayed images illustrated in the figures or described herein are executed or produced in response to one or more sets of instructions stored in or on computer readable storage media. The functions, acts, or tasks are independent of the particular type of instruction set, storage media, processor or processing strategy and may be performed by software, hardware, integrated circuits, firmware, micro code and the like, operating alone or in combination, and may be displayed by any of the visual display techniques as are known in the art, including virtual reality, LCD displays, plasma displays, projection displays and the like. Processing strategies may include multiprocessing, multitasking, parallel processing, distributed processing, and the like. In another aspect, the instructions may be stored in a remote location for transfer through a computer network, a local or wide area network or over telephone lines. In a further aspect, the instructions are stored within a given computer or system.

Provision may be made for obtaining, converting and storing the necessary data, and for the archiving of such data. Further, the overall architecture may make provision for the various components to be geographically distributed while operating in a harmonious manner. Data may be stored in the same or similar media as is used for instructions.

To support multiple users at geographically distributed locations, web-based applications and devices may be used. Where the terms “web”, “network” or “Internet” are used, the intent is to describe an internetworking environment, which may include both local and wide area networks, where defined transmission protocols are used to facilitate communications between diverse, possibly geographically dispersed, entities. An example of such an environment is the world-wide-web (WWW) and the use of the TCP/IP data packet protocol, and the use of Ethernet or other hardware and software protocols for at least some of the data paths.

When first purchasing a system, a customer may be offered additional options that are available for purchase. As is typical, the customer may be offered the opportunity at a later time to purchase both old after sales support items that are still available, and any of the after sales support items that are or become available.

The “lifetime” of a system may be variously defined, and any one of the usual economic or empirical definitions may apply in this description. Systems are typically used during a period of time or lifetime where the function of the system, such as in medical treatment or diagnosis, is considered to be appropriate, given the state of knowledge of the field of practice. In another aspect, the lifetime of the equipment may be governed by the cost of operating the equipment, including maintenance and training, when compared with other available equipment. Sometimes the lifetime of the system may be related to the continued after sales support being provided by the manufacturer thereof, in either an economic or utility sense.

The term software includes one or more executable computer instruction modules or packages, which may be a part of, or integrated with, the overall operation of a system, and which may be separately identified for the purpose of licensing the use thereof.

In an aspect, the customer may be offered opportunity to purchase any of the options not purchased at the time of initial sale, as well as the now available after sales support. The software options may be acquired by the customer on either a one-time-payment license, or as a pay-per-use license. In either instance, the customer may be offered the opportunity to immediately download the software over the Internet or similar network, and put the option to immediate use in production or testing. With respect to the pay-per-use license, the customer can test the software and determine whether to continue on a pay-per-use basis or purchase a one-time-payment license.

A one-time-payment license may be characterized by a relatively high price with respect to a pay-per-use license, but affords the customer the right to unlimited use of the software in the owned medical system. In contrast, pay-per-use licenses are characterized by a lower price for occasional use. The price of a pay-per-use license may be established to recover part or all of the estimated training cost for evaluation use.

The pricing of the pay-per-use license and the sharing of the income with the marketing and sales organization may be used as an incentive to the marketing and sales organization to provide customer support and to encourage the sales personnel to be familiar with the after sales support being offered.

A customer may continue to use the pay-per-use license indefinitely at a stipulated price per use, a price for a specific number of uses, or the like. Such pricing models provide for occasional use of an option, and such a price may be incorporated into the price for the user, consumer, patient or insurer, for the service provided.

Alternatively, a form of license intermediate between the pay-per-use license and a one-time payment license may be offered, where the license is valid for a period of time, such as a year on an unlimited use basis or a maximum number of uses.

The customer may choose to purchase a one-time payment license. Such licenses are also called paid-up licenses. A paid-up license may include the right to unlimited use of the software package, and may include a fixed amount of training, or other service. Alternatively, training and the like may be sold separately.

In another aspect, a pay-per-use license may be converted into a paid-up license, and a credit, or partial credit, may be given for previous payments under the pay-per-use license. When a pay-per-use license is used, the user may have to contact the manufacturer, usually by electronic means, to secure authorization for each use, or a fixed number of uses, so that a bill for the usage can be rendered. Alternatively, the installed software may track and report the use of each of the software modules either directly or indirectly to the manufacturer for the purpose of billing.

As a system is supported by a manufacturer throughout the economic lifetime thereof, the options available to a customer may change, generally being of increased number, but also making obsolete some software packages, whose functions have been incorporated into newly designed software packages.

In an aspect, the supplier may maintain a data base of all installed system software and options, or at least the installed product options where an owner or leaser has subscribed to an update service. When an update to the software, for example, is made available by the supplier as an option, the record in the data base for each installed product is scanned to determine if the update is applicable to the system. Where a match between the installed system, which may be termed an “entity,” and a compatible update is found, at least one of a number of actions may be initiated:

notify the local sales organization;

send an email or other communication to the designated administrator of the customer associated with the entity;

automatically download the software to the entity;

download the software to the entity based on a specific request; or

send a copy of the software to the customer on a removable computer-readable medium.

Downloads may be either automatic or manual, or may be made by other computer readable distribution media such as CD-ROM, DVD and the like, depending on the product capabilities and customer requirements. Where software is automatically downloaded, the software may be automatically installed, or queued for installation at a scheduled time, or notified to the customer such that a decision as to whether to download the software may be made.

The decision as to use may also include the selection, for example, of a trial license, which may be a gratis pay-per-use license for a fixed number of uses or a fixed time period a paid-up license or a pay-per-use license. A trial license results in the software being downloaded with an expiration date or a limit on the number of uses, after which the software may become inoperative, or be converted into, for example, a pay-per-use license or a paid-up license. Such conversion of license type may be either automatic at the conclusion of the trial license period or manual, in accordance with the terms of the license agreement or other arrangement between the parties. A mixture of trial-licensed, pay-per-use and paid-up licenses may be operable on a single entity in a harmonious manner. The difference between them being the fee being charged each time the software program is executed. In the case of the trial license and the paid up licenses, the use may be free of further charge; in the case of the pay-per-use license, a fee may be due for each use or group of uses of the software program.

The supplier data base is updated to maintain the status of the software configuration on each entity. Where there is a change in the licensing structure, for example from a trial license to a paid-up license, an invoice for the price is generated through the supplier accounting system.

Where a pay-per-use license is selected and the software installed on the entity by one of the methods described above, the entity may thus be configured to permit the use of the software program and to determine when the software program is used by the customer.

When a software program on an entity is used, the use is recorded. Typically the time, the date, the duration of use, and the account number of the user or, for example the patient may be either automatically recorded or be manually entered through a computer terminal or other data entry device. The usage records may be processed in a number of ways to account for and bill for the pay-for-use activity.

In an aspect, the usage information may be collected locally at the entity by the software, and forwarded immediately or periodically to a data processing center at the customer site. The periods may be hourly or daily, for example. Alternatively, if the entity is capable of external communications, the information may be forwarded to a data center at the supplier. The selection of data processing method, data security, data integrity and related matters, including the methods of billing and of paying for the use of the software program, are usually controlled by governmental regulations, and the details of performing the accounting, data processing and data transmission will therefore be different in different geographical areas and countries.

Where a pay-per-use license is used, the customer may request initial training support if such training was not supplied as part of a trial license, or if a trial license was not elected. This support would be scheduled with the sellers training staff and may be recorded in the data base record associated with the entity.

As such, the listing and description of the after sales support modules or options that are available maybe by creating a data base of such modules accessible through a server. In this approach, the manufacturer, seller, distributor or reseller may provide data in the data base describing the modules, including availability, functional description, related research literature, hardware support requirements, price for, for example, for evaluation, pay-per-use and paid-up license, training and the like. Customers may conveniently access the data base remotely through a wide area network, such as the Internet, to learn about the modules available for equipment and systems being purchased or already owned. This information may be maintained in a current state by the manufacturer, and used by the customer to configure an initial purchase, or to upgrade an existing medical system.

In an alternative, the data base may be scanned to determine the applicability of the after sales support modules to an entity, and the modules downloaded, or transmitted by computer readable media, and installed as previously described.

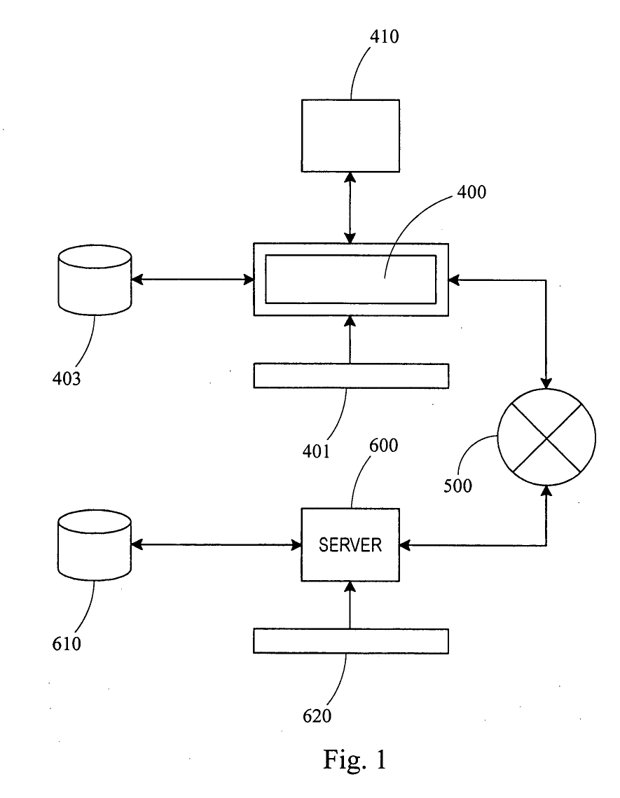

A system for providing the option modules is shown in FIG. 1.

The manufacturer may create and maintain a data base of modules and module characteristics, as previously described. The data of the data base and the software of the option modules are stored on a mass storage device 610 accessible by a server 600 having an interface to a network 500, which may be the Internet. The data base may be maintained by a keyboard and display 620. The keyboard and display 620 is representative of any means of data input to the server for incorporation into the data base, and may include receiving data over a local or wide are a network, or the Internet, manual data entry, entry of data through other means such as CD-ROM, DVD, removable disk media, and the like.

A customer or user may have a computer, which may be a personal computer 400 having a keyboard and display 401 and a mass storage device 403, such as a disk drive or the like for storing an operating system, application programs, communications software and the like. The mass storage device 403 may also store modules of software for the medical system that were originally purchased or may subsequently be purchased from the manufacturer under one or more licenses. The computer 400 may communicate with the server 600 over a network 500, which may be the Internet. The computer 400 may also communicate with or be part of the medical system 410 being supported by the after sales support, so that software modules may be transferred to the system 410 and the usage of the modules reported. While this connection may be a data link over a network, the software modules may be manually transferred to the system 410 from the manufacturer, distributor or seller, and manually installed.

In an aspect, a method of purchasing a module for use with a medical system includes: requesting information about available software modules for a specific system; receiving information over a wide area network regarding the modules currently available; selecting desired modules and conditions of purchase; placing the order; receiving a file or computer readable media containing the purchased module, including conditions of use; and, installing the module on the medical system. The term order or purchase may also include the selection of an initial gratis trial license in the form of a pay-per-use license.

In another aspect, a method of selling after sales support for a medical system includes: preparing a data base of available after sales support modules and storing the data base on a computer readable medium; receiving requests for information relating to after sales support pertaining to a specific model of medical system; retrieving information regarding the after sales support from the data base; transmitting the information over a wide area network; receiving an order from a customer over the wide area network; using a server to retrieve the ordered after sales service module from the computer readable medium; and transmitting the after sales service module to a customer. Transmitting is understood to include the use of data communications networks, such as the Internet, and physical computer readable media.

In another aspect, the method of selling may further include maintaining a data base of previously purchased modules for each medical system for each customer; comparing the available modules with previously purchased modules for the each system of the customer requesting the information; identifying the status of the available modules for the customer and including the identification and status information in the information sent to the customer; receiving an order from the customer; and, updating the data base of customer records to indicate the effect of the latest purchase.

In yet another aspect, the method of selling may include; notifying the customer of each medical system of new modules or conditions of sale of modules available for the specific model of medical system previously purchased.

In still another aspect, the method of selling may include manually or automatically downloading new modules to the medical system and identifying the modules having licenses as trial modules, paid up modules or pay-per use modules. Pay-per-use modules initiate data collection regarding the use thereof, and report the data to either a customer data center to the seller data center. A summary of the usage of the module may be used to generate an invoice for the sued of the module, to secure reimbursement for use by the customer from an insurer, or the like.

In a further aspect, the usage records may be used by the seller to determine sales effectiveness, to allocate revenue between the sales organization and the manufacturing organization, and the like. Allocating revenue may be an important aspect of incentivizing the seller's employees to provide support for the after sales modules distributed as described above.

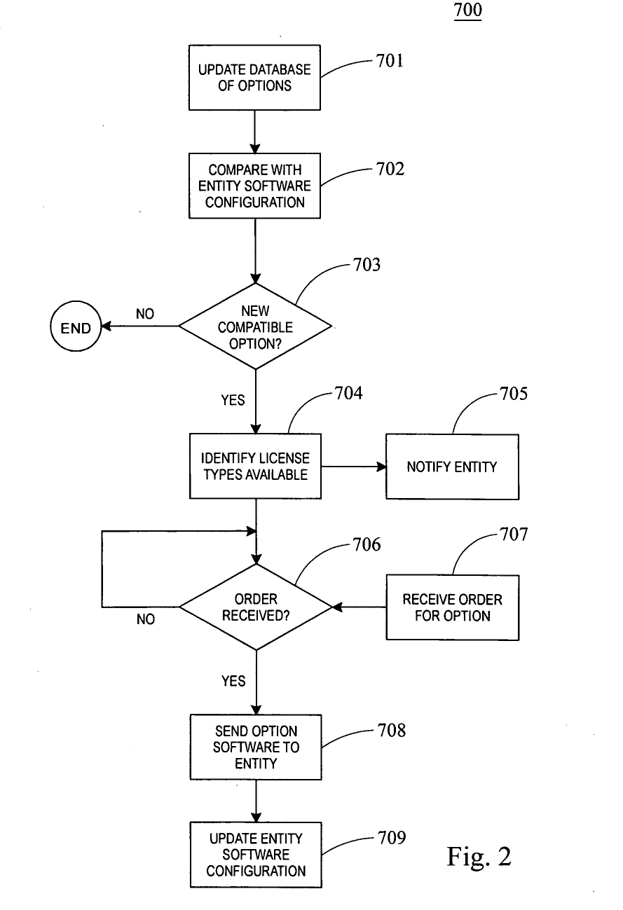

In an example, a method of selling licenses for software-modules is shown in FIG. 2. The method 700 includes the acts of: 701 updating a data base of software options for a system; 702 comparing the software configuration of an entity with the updated data base; and, 703 determining if the updated data base contains a compatible software module not in the entity software configuration. Acts 702 and/or 703 may be performed by a processor or manually. The method further includes 704 identifying the compatible software module with available license type information and 705 notifying the entity that a new compatible software module is available; 706 waiting for an order for a license; 707 receiving an order; 708 sending the ordered software module to the entity; and, updating the data base of entity software, including the type of license ordered.

In another example, a method of selling software licenses includes the acts of sending new or updated software to a customer, including a pay-per-use license; processing orders received from a customer for additional uses or time duration for the software; furnishing the additional use or time duration license to the customer. The method may also include the acts of receiving an order from a customer to convert the pay-per-use license to a paid-up license, and sending the paid-up license to the customer.

The act of sending the new or updated software and the pay-by-use license may include activating the pay-by-use license either for a prepaid number of uses, a chargable number of uses, a gratis number of uses, a prepaid time period, or a gratis time period.

The act of sending the software may include one of transmitting the software to the customer over the Internet, a VPN or by removable computer readable media. The act of sending a license may include the same acts as for sending software, or may include sending a paper or other readable copy of the license including a key. The key may be a pass-phrase, a serial number or other coded access data, or a physical key. The physical key may be in the form of a computer device having a computer readable memory.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A data processing system for providing software for a medical system, comprising:
a server communicating with a data base containing records of a software configuration of an entity and software modules for distribution, the server configured to determine if a software module is compatible with the software configuration of the entity;
wherein at least one of a email message describing the software module, a physical copy of the software module, or an electronic copy of the software module is transmitted to one of a customer or the entity when a compatibility is found, and a record of a license status and usage of the software module is maintained for software modules subject to a pay-per-use license.

2. The data processing system of claim 1, wherein the server receives a message over a network from the entity reporting each use or group of uses of the software module.

3. A medical system, comprising;
a sensor system; and
a controller having an external data interface;
wherein a software program having a pay-per-use license is installed on the controller, and a record of each use is stored in the controller or transmitted through the external interface.

4. A method of selling after sales support for a medical system, the method including:
creating and maintaining a data base of software modules available for an entity;
comparing a software configuration for the entity with the data base to determine compatibility of a software module option with the software configuration of the entity;
sending one of a physical copy of the compatible software module option program, or an electronic copy of the compatible software module option to the entity;
identifying a license status of the compatible software module option such that a usage of the compatible software module option is recorded by the entity;
receiving a report of the usage from the entity, either directly or indirectly.

5. A method of purchasing after sales support for a medical system, the method including:
requesting information regarding after sales support from a manufacturer over a wide-area network;
receiving information from the manufacturer regarding available software modules for the specific model and configuration of medical system of the customer, the information being received as data modulated on a carrier wave;
selecting a specific software module from the one or more available software modules, including a type-of-use license; and
sending a request for the specific selected module to the manufacturer.

6. The method of claim 5, further comprising receiving the specific selected module from the manufacturer and installing the specific selected module in the medical system.

7. The method of claim 5, wherein the specific selected module is received as data modulated on a carrier wave.

8. The method of claim 5, wherein when a “pay-by-use” license is purchased, the usage of the specific selected module is recorded and a fee is charged.

9. A method of selling software licenses for medical systems, the method including:
sending new or updated software to a customer, including an initial pay-by-use license;
receiving and processing orders from the customer for one of an additional pay-by-use license, or conversion of a pay-by-use license to a paid-up license;
providing the additional pay-by-use license or paid-up license to the customer.

10. The method of claim 9, wherein the step of sending to a customer includes at least one of transmitting the software by encoding data on a carrier wave, transmission of data over the Internet, or a virtual private network.

11. The method of claim 9, wherein the step of sending to a customer includes recording the software data on a removable computer readable medium and physically sending the removable computer readable medium to the customer.

12. The method of claim 9, wherein the initial pay-per-use license may be for one of a specified number of occasions of use of the software, a specified period of time, a specified expiration date.

13. The method of claim 12, wherein the initial pay-by-use license is provided free of charge.
